(19) United States
(12) Patent Application Publication
(10) Pub. No.: US 2014/0200879 A1
(43) Pub. Date: Jul. 17, 2014

(54) Method and System for Rating Food Items

(71) Applicants: Brian Sakhai, Old Westbury, NY (US); Benjamin Sakhai, Old Westbury, NY (US)

(72) Inventors: Brian Sakhai, Old Westbury, NY (US); Benjamin Sakhai, Old Westbury, NY (US)

(21) Appl. No.: 13/739,114

(22) Filed: Jan. 11, 2013

(51) Int. Cl. G06Q 30/02; G06Q 50/22

(52) U.S. Cl. CPC G06Q 30/0282; G06Q 50/22
USPC 704/9

(57) ABSTRACT

A networked computer system for calculating a rating of a food. The computer system includes a database comprising a plurality of records and a personal computer system. Each record in the database includes a natural language description of a respective food and a rating of the respective food. The database further comprising an index comprising indexed natural language descriptions corresponding to the natural language descriptions in the records. The personal computer system includes an input module configured for receiving a request to calculate a rating for a requested food item and for extracting inputted natural language descriptions of the requested food item in the request. Also included is an input processing module configured for identifying tokens in the inputted natural language descriptions, a query module configured for querying the database; and a rating module configured for calculating the rating for the requested food item based on the query result.

### FIELD OF THE INVENTION

The present invention relates to a system and method for assigning a health-related rating to a food item and, more specifically, to a system and method for assigning a health-related rating to a food item lacking specificity, e.g., in regards to portion size, ingredients, and nutritional information.

### BACKGROUND OF THE INVENTION

Available resources have been unable to evaluate a consumer's request for information without requiring a burdensome amount of information in a structured manner. In conventional nutritional systems, specifying “turkey sandwich” provides insufficient information for the system to determine a health-related rating for such choice because “turkey sandwich” is not specific as to the size, ingredients, or nutritional information of a turkey sandwich. This may be thought of as a “Turkey Sandwich Problem.”

To address such short comings, conventional systems may require consumers to provide further specifics regarding the food items they want rated. For example, with respect to a turkey sandwich, a conventional system might require the consumer to provide a breakdown of items in the sandwich (e.g., turkey, lettuce, tomato, avocado, mayonnaise, bread) and measurements for each item (e.g., ½ lb. turkey, ½ cup of lettuce, 2 slices of tomato, 1 tablespoon of avocado, 1 tablespoon mayonnaise, 2 slices of bread), and often might require further specifics, such as the types of certain items (e.g., processed turkey, light mayonnaise, whole wheat bread, etc.).

### SUMMARY OF THE INVENTION

In accordance with an aspect of the present invention, there is provided a networked computer system for calculating a health-related rating of a food item. The networked computer system includes a database and a computer system. The database comprises a plurality of records, each of which includes one or more natural language descriptions of a respective food item and a health-related rating of the respective food item. The computer system comprises an input module, an input processing module, a query module, and a rating module. The input module is configured for receiving a request to calculate a health-related rating for a requested food item. The request comprises one or more inputted natural language descriptions of the requested food item. The input processing module is configured for processing the one or more inputted natural language descriptions to generate one or more processed natural language descriptions. The query module is configured for querying the database based on the one or more processed natural language descriptions. The rating module is configured for receiving a results set from the database in response to the querying, and calculating the health-related rating for the requested food item based on the results set.

In accordance with another aspect of the present invention, there is provided a method for calculating a health-related rating of a food item. The method includes steps of receiving a request to calculate a health-related rating for a requested food item. The request includes one or more inputted natural language descriptions of the requested food item. The method further includes a step of processing the one or more inputted natural language descriptions to generate one or more processed natural language descriptions and a step of querying a database based on the one or more processed natural language descriptions. The database includes a plurality of records, each record including one or more natural language descriptions of a respective food item and a health-related rating of the respective food item. The method also includes a step of receiving a results set from the database in response to the querying and a step of calculating the health-related rating for the requested food item based on the results set.

In accordance with yet another aspect of the present invention, there is provided a tangible computer-readable medium comprising software instructions stored thereon that when executed by a computer system cause the computer system to carry out a plurality of steps including a step of receiving a request to calculate a health-related rating for a requested food item, which request includes one or more inputted natural language descriptions of the requested food item, a step of processing the one or more inputted natural language descriptions to generate one or more processed natural language descriptions, a step of querying a database based on the one or more processed natural language descriptions, which database includes a plurality of records, each record including one or more natural language descriptions of a respective food item and a health-related rating of the respective food item, a step of receiving a results set from the database in response to the querying, and a step of calculating the health-related rating for the requested food item based on the results set.

### BRIEF DESCRIPTION OF THE DRAWINGS

For the purpose of illustration, there are shown in the drawings certain embodiments of the present invention. In the drawings, like numerals indicate like elements throughout. It should be understood that the invention is not limited to the precise arrangements, dimensions, and instruments shown. In the drawings:

FIG. 1 illustrates an exemplary embodiment of a networked computer system for calculating the health-related rating of a food item, in accordance with an exemplary embodiment of the present invention;

FIG. 2 illustrates a block diagram of an exemplary embodiment of a software application for calculating the health-related rating of a food item, in accordance with an exemplary embodiment of the present invention;

FIG. 2A illustrates a block diagram of another exemplary embodiment of a software application for calculating the health-related rating of a food item, in accordance with an exemplary embodiment of the present invention;

FIG. 3 illustrates a flow chart of an exemplary embodiment of a method for calculating a health-related rating of a food item, the method comprising a step of processing a natural language description of a food item, querying a database, and calculating the health-related rating of the food item based on a results set returned from the database, in accordance with an exemplary embodiment of the present invention;

FIG. 4A illustrates a computer form for receiving one or more inputted natural language descriptions of a food item to be assigned a health-related rating, in accordance with an exemplary embodiment of the present invention;

FIG. 4B illustrates the computer form of FIG. 4A displaying a health-related rating of a food item, in accordance with an exemplary embodiment of the present invention;

FIG. 5 illustrates a restaurant menu comprising natural language descriptions of a plurality of food items and respective health-related ratings calculated in accordance with the method of FIG. 3; and

FIG. 6 illustrates a flow chart of sub-steps of an exemplary embodiment of the step of FIG. 3 of processing the natural language description of the food item, in accordance with an exemplary embodiment of the present invention.

### DETAILED DESCRIPTION OF THE INVENTION

Reference to the drawings illustrating various views of exemplary embodiments of the present invention is now made. In the drawings and the description of the drawings herein, certain terminology is used for convenience only and is not to be taken as limiting the embodiments of the present invention. Furthermore, in the drawings and the description below, like numerals indicate like elements throughout.

Conventional nutritional-rating systems suffer from a number of shortcomings. In conventional systems in which the consumer is required to enter specifics for a food item, e.g., a breakdown of ingredients in the food item, measurements of each ingredient, types of certain ingredients, etc., he may be able to do so if he prepared the food item. The amount of work required to provide these specifics makes such systems cumbersome to the consumer. In a setting in which he has not made the food item (e.g., ordering at a deli, restaurant, etc.), it becomes overly difficult and even impossible to provide these specifics.

Some conventional systems have tried to overcome the problem of the difficulty or burden of providing measurements of ingredients by prompting the consumer to compare portion sizes to measurements that he may visualize more easily. For example, such systems may prompt the consumer to enter an indication of an approximate size of the food item (e.g., 1 portion of meat=1 deck of cards). This solution often results in a guessing game for the consumer and, hence, the feedback might be unreliable. If the consumer underestimates the size of the food item, the system may report that the food item is more healthful than it really is. In extreme cases, there is an incentive for the consumer to underestimate the size of the food, as it would indicate a healthier diet.

Another problem with the conventional nutritional-rating systems described above is that they require the consumer to have access to the food items in order to input the information necessary for the nutritional ratings of the food items to be calculated. In many settings, especially food establishments, consumers do not have access to their food items when making their choices. It is at this time, however, that a consumer may have the most use for having possible food selections rated so that he may consider such information when making a choice. The consumer cannot be expected to properly input all information for the food items he is considering ordering without having access to them. Accordingly, it would be desirable for there to be a nutritional rating system that allows consumers to more easily evaluate their food choices.

In accordance with an exemplary embodiment of the present invention, there is provided a health-related rating system that allows for the evaluation of a food item, represented by one or more natural language descriptions, to return a health-related rating irrespective of specificity, portion size, ingredient lists, or nutritional information of the food item or its ingredients. An exemplary application of this system is for food items found on restaurant menus. Restaurant menus are loosely structured, often only broken down into a name and description for each food item, and usually do not identify the ingredients or their measurements or provide any sort of nutritional or health-related information for the food items listed thereon.

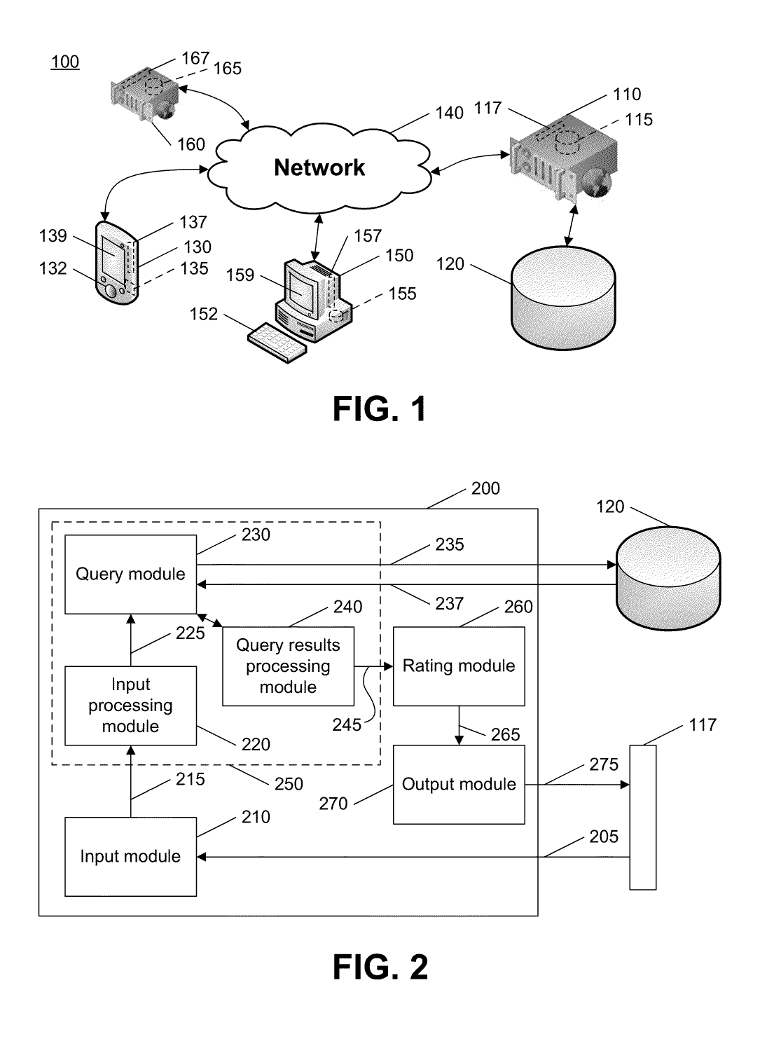

Illustrated in FIG. 1 is an exemplary networked computer system, generally designated as 100, in accordance with an exemplary embodiment of the present invention. The networked computer system 100 comprises a server 110 connected to a plurality of remote computer systems, such as a mobile computer system 130, a personal computer system 150, and a server 160, via a network 140. In an exemplary embodiment, the network 140 is the Internet, and the servers 110 and 160 are web servers, each hosting a website accessible by the computer systems 130 and 150.

The server 110 comprises an internal storage device 115, which comprises a tangible computer-readable storage medium, such as a hard disk array or solid-state memory, for storing software instructions that, when executed by the server 110, carry out relevant portions of the methods described herein. The server 110 maintains a database 120 for storing data associated with food items, as described in further detail below. The database 120 may be internal to the server 110, in which case it is stored on the storage device 115, or it may be external to the server 110, in which case it may be stored on an external storage device, such as an external hard disk array or solid-state memory.

The database 120 stores information on a plurality of food items, which are represented by their natural language descriptions. Each record in the database 120 comprises one or more fields, each of which comprises one or more natural language descriptions for a respective food item and an associated numeric health-related rating of the respective food item. The numeric health-related rating of the food item stored in each record may be a normalized number (e.g., normalized to a predetermined scale) or may be a non-normalized number, in which case it is normalized during the process for rating a queried food item.

In an exemplary embodiment of the database 120, the fields of the database 120 comprise structured data (one or more natural language descriptions) that have been indexed and may be queried separately when appropriate to gain more accurate results. For example, in this exemplary embodiment, the one or more natural language descriptions for a food item may comprise a natural language description for a name of the food item and a natural language description for a description of the food item in separate fields in the record. Thus, each record in the database comprises a string field for a name (a first natural language description) of the food item, a string field for a description (a second natural language description) of the food item, and a numeric field for a rating of the food item in respective Name, Description, and Rating fields. The natural language descriptions for the name and description of the food item may be indexed for querying later. Thus, the database 120 further comprises an index of the records in the database 120.

In another example of the database 120, the one or more natural language descriptions for a food item may further comprise any of a natural language description for a brand name, a natural language description providing restaurant information, e.g., restaurant name, a natural language description for a category of the food item, e.g., a “dessert” or “beverage,” a natural language description for the cuisine of the food item., e.g., “Southern,” “That,” etc. Each record in the database comprises respective fields (Brand field, Restaurant field, Category field, Cuisine field, etc.) for these further natural language descriptions, and these further natural language descriptions may be indexed for querying later.

As an example, suppose a food item is listed on a menu at XYZ Diner as an appetizer having the following description: “Stuffed Baked Potato with broccoli & cheddar cheese.” If the database 120 were to include a record of this food item with fields for Name, Description, Category, Restaurant, and assigned health-related Rating, such fields may have the following values:

Name=“Stuffed Baked Potato”

Description=“with broccoli & cheddar cheese”

Category=“Appetizer”

Restaurant=“XYZ Diner”

Rating=“5.2”

In yet another example of the database 120, the one or more natural language descriptions for a food item may further comprise an additional field that is a concatenation of the one or more natural language descriptions in some or all of the other fields of such record. This field may be referred to as “Main Data” and the concatenated natural language description contained therein may be referred to as a “master string.” This string provides an additional field to query against and the option of querying against this field only. When querying against this field only, the application 200, 200′ can still get the benefit of asking the user to supply a separate name and description, even though they will be combined. The Main Data field provides a performance boost by allowing for a query against one field only, instead of having a query that looks for matches between inputted name in the Name field, inputted description in the Description field, inputted name in the Description field, and inputted description in the Name field. It is to be understood that some natural-language descriptions may be omitted from the Main Data field. For example, the Category field may be included as a separate field in the database but may be omitted from the Main Data field.

Building on the example above, in the record for the “Stuffed Baked Potato with broccoli & cheddar cheese” appetizer at XYZ Diner, there may be an additional Main Data field with the following value (master string): “Appetizer Stuffed Baked Potato with broccoli & cheddar cheese.” In this example, the master string does not include the restaurant value, but it is to be understood that in other exemplary embodiments the restaurant value may be included.

In still another exemplary embodiment of the database 120, the database 120 comprises separate records comprising different respective natural language descriptions for the same food item, as there may be numerous ways to describe the same food item. By including more than one record that describes the same food item, but in different ways, the database 120 provides a way for increasing the accuracy of queries and, more specifically, the determination of the numeric heath-related rating of a food item. For example, the database 120 may include a record having the natural language description of “turkey sandwich” and another record having the natural language description of “turkey, lettuce, tomato, and mayo on a roll.” Each of these records describes the same food item. Furthermore, the database 120 may comprises separate records having the same natural language descriptions for the same food item but with different ratings. The different ratings may arise from different raters rating the same food item with a different health-related rating. For example, the database 120 may comprise three records of “turkey sandwich” with three separate ratings, which are possibly different from one another.

Continuing with FIG. 1, the mobile computer system 130 and the personal computer system 150 respectively comprise internal storage devices 135 and 155, each of which comprises a tangible computer-readable storage medium, such as a hard disk array or solid-state memory, for storing software instructions that, when executed respectively by the computer systems 130 and 150, carry out relevant portions of the methods described herein. The mobile computer system 130 further comprises an input interface 132, an output interface 139, and a network interface 137. In an exemplary embodiment, the input interface 132 is a miniature keyboard or one or more buttons, and the output interface 139 is a computer screen. In another exemplary embodiment, the input interface 132 is integral with the output interface 139, the interfaces 132 and 139 being a touch screen. The personal computer system 150 further comprises an input interface 152, an output interface 159, and a network interface 157. In an exemplary embodiment, the input interface 152 is a keyboard and/or mouse, and the output interface 159 is a computer screen. In another exemplary embodiment, the input interface 132, 152 is a microphone for receiving voice input from a user.

The server 160 comprises an internal storage device 165, which comprises a tangible computer-readable storage medium, such as a hard disk array or solid-state memory, for storing software instructions that, when executed by the server 160, carry out relevant portions of the methods described herein, including hosting a website that comprises a menu of a restaurant. The menu is stored on the internal storage device 165 and is accessible over the network 140.

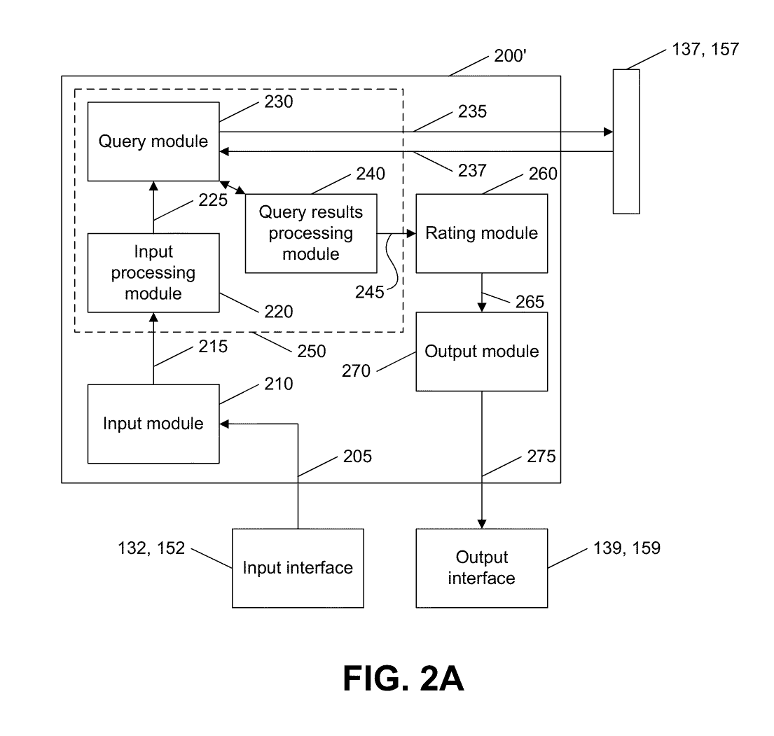

Referring now to FIG. 2, there is illustrated a functional block diagram of an exemplary embodiment of a software application, generally designated as 200, stored in the internal storage device 115 and executed on the server 110, in accordance with an exemplary embodiment of the present invention. The software application 200 comprises an input module 210 configured for receiving one or more strings of text comprising one or more natural language descriptions 215 of a food item as an input 205. The input module 210 is configured to pass the one or more natural language descriptions 215 to a search engine 250 for searching for health-related ratings in the database 120 using the one or more natural language descriptions 215.

The search engine 250 comprises an input processing module 220, a query module 230, and a query results processing module 240. The input processing module 220 is configured to process the one or more natural language descriptions 215 and to pass one or more processed natural language descriptions 225 to the query module 230. The query module 230 is configured to transmit one or more queries 235 to the database 120 for assigned health-related ratings in records that include one or more natural language descriptions that match one or more of the one or more processed natural language descriptions 225.

The database 120 is configured to return a results set(s) 237, for the one or more queries 235, to the query module 230. The query module 230 is configured to pass the results set(s) 237 to the query results processing module 240, which is configured to process the results set(s) 237 and pass one or more processed results 245 to a rating module 260. The rating module 260 is configured to calculate a rating 265 for the food item described in the one or more natural language descriptions 215 based on the one or more processed results 245. The rating module 260 is configured to pass the calculated rating 265 to an output module 270, which is configured to output the rating 265 as an output 275.

In the exemplary embodiment illustrated in FIG. 2, the software application 200 is executed on the web server 110. The software application 200 receives the input 205 via the network interface 117 over the network 140 from one of the computer systems 130 or 150 or from the server 160. The computer system 130 or 150 or the server 160 transmits the input 205 via its network interface 137, 157, or 167. The software application 200 may communicate directly with the database 120 or via an internal network. The software application 200 transmits the output 275 though the network interface 117 over the network 140 to an intended recipient, such as any of the computer systems 130 or 150, for display on the output interface 139 or 159, or to the server 160 for storage on the internal storage device 165. The computer system 130 or 150 or the server 160 receives the output 275 via its network interface 137, 157, or 167.

Referring now to FIG. 2A, there is illustrated another exemplary embodiment of the software application 200, generally designated as 200′, in accordance with an exemplary embodiment of the present invention. The software application 200′ is stored in one or more of the storage devices 135, 155, and 165 and is respectively executed on the mobile computer system 130, the personal computer system 150, or the server 160 rather than on the web server 110. The software application 200′ is similar to the software application 200, the differences being where they are executed and the interfaces with which the software applications 200 and 200′ interact because the software applications 200 and 200′ are executed on different computer systems.

When executed on the mobile computer system 130, the software application 200′, or more specifically the input module 210, is configured to receive the input 205 from the input interface 132, and the software application 200′, or more specifically the output module 270, is configured to provide the output 275 to the output interface 139. The software application 200′, or more specifically the query module 230, is configured to communicate the one or more queries 235 and to receive the results set(s) 237 from the database 120 through network communications with the server 110 over the network 140 via a network interface 137.

When executed on the personal computer system 150, the software application 200′, or more specifically the input module 210, is configured to receive the input 205 from the input interface 152, and the software application 200′, or more specifically the output module 270, is configured to provide the output 275 to the output interface 159. The software application 200′, or more specifically the query module 230, is configured to communicate the one or more queries 235 and to receive the results set(s) 237 from the database 120 through network communications with the server 110 over the network 140 via a network interface 157.

When executed on the server 160, the software application 200′, or more specifically the input module 210, is configured to receive the input 205 from the internal storage device 165, and the software application 200′, or more specifically the output module 270, is configured to provide the output 275 to the internal storage device 165 for storage thereon. The software application 200′, or more specifically the query module 230, is configured to communicate the one or more queries 235 and to receive the results set(s) 237 from the database 120 through network communications with the server 110 over the network 140 via a network interface 167.

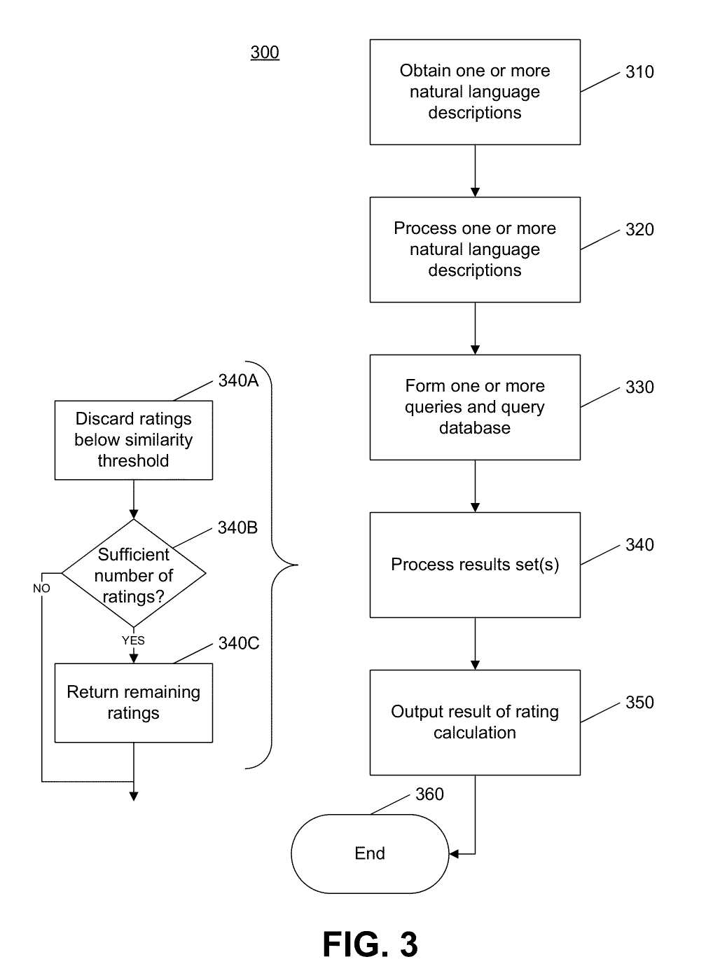

Illustrated in FIG. 3 is an exemplary method 300 by which the software applications 200 and 200′ calculate and assign the health-related rating of a food item, in accordance with an exemplary embodiment of the present invention. The method 300 begins with a Step 310 in which the input module 210 of the software application 200, 200′ receives the input 205, which comprises one or more natural language descriptions 215 of a food item. (The input 205 includes a request for the application 200, 200′ to calculate the health-related rating of the food item described by one or more natural inputted language descriptions 215 contained in the input or request 205. Below, such a request is also referred to as a “request 205” as it is contained within the input 205.) When the method 300 is performed by the software application 200, the input module 210 receives the request 205 via the network interface 117 in the Step 310. When the method 300 is performed by the software application 200′, the input module 210 receives the request 205 via the input interface 132 or 152 or from the internal storage device 165 (depending on whether the software application 200′ is being executed on the mobile computer system 130, the personal computer system 150, or the server 160) in the Step 310.

In the Step 310, the input module 210 strips the one or more inputted natural language descriptions 215 from the request 205 and passes the one or more inputted natural language descriptions 215 to an input processing module 220. The method 300 proceeds to a Step 320 in which the input processing module 220 receives and processes the one or more inputted natural language descriptions 215 in preparation for querying the database 120. The input processing module 220 outputs one or more processed natural language descriptions 225 as a result of processing the one or more inputted natural language descriptions 215 and passes the one or more processed natural language descriptions 225 to a query module 230.

The query module 230 receives the one or more processed natural language descriptions 225 and creates one or more queries 235, Step 330. In the Step 330, the query module 230 queries the database 120 with the one or more queries 235, the database 120 returns a results set(s) 237, and the query module 230 forwards the results set(s) 237 to a query results processing module 240. The results set(s) 237 comprises one or more records of food items in the database 120 or select portions of the records of food items in the database 120 that satisfy criteria in the one or more queries 235. In an exemplary embodiment, results set(s) 237 further comprises, for each result in the results set(s) 237, a respective similarity or match score. Similarity scores may be based on multiple factors and need not be uniform between search engines 250 of different applications 200, 200′. The similarity score of one result relative to another provides information as to their relative relevance.

When the method 300 is performed by the software application 200, the query module 230 queries the database 120 directly and receives the results set(s) 237 directly from the database 120 in the Step 330. When the method 300 is performed by the software application 200′, the query module 230 transmits the one or more queries 235 to the database 120 via the network interface 137, 157, or 167 (depending on whether the software application 200′ is being executed on the mobile computer system 130, the personal computer system 150, or the server 160) and receives the results set(s) 237 from the database 120 via the network interface 137, 157, or 167 (depending on whether the software application 200′ is being executed on the mobile computer system 130, the personal computer system 150, or the server 160) in the Step 330.

In an exemplary embodiment, in the Step 330, the query module 230 creates the query 235 as a single, complex query comprising the one or more processed natural language descriptions 225. One set of results 237 is returned from the database 120 comprising one or more results, e.g., one or more unique records of food items or select fields of the one or more unique records of food the items and, optionally, their respective similarity or match scores. The one or more results in the results set 237 are unique, i.e., there are no duplicates. In this exemplary embodiment, to the extent that the input processing module 220 determines from the one or more processed natural language descriptions 225 that they comprise more than one processed natural language description to be queried upon, the query module 230, in the Step 330, generates a complex query for all processed natural language descriptions contained in the one or more processed natural language descriptions 225. The results set 237 comprises the results of querying the database 120 on all of these processed natural language descriptions.

In another exemplary embodiment, in the Step 330, the query module 230 creates the one or more queries 235, a plurality of simple queries 235, each comprising only one of the one or more processed natural language descriptions 225 to be queried against a field in the database 120. The query module 230, in the Step 330, queries the database 120 more than one time, i.e., with more than one simple query 235. Accordingly, more than one results set 237 is returned. Each set of results 237 is returned from the database comprising one or more results and, optionally, their respective similarity scores. The results in each results set 237 are unique, i.e., there are no duplicates, but the results across all results sets 237 may not be unique, i.e., there may be duplicates, i.e., there may duplicates across the results sets 237. In this exemplary embodiment, to the extent that the input processing module 220 determines from the one or more processed natural language descriptions 225 that they comprise more than one processed natural language description to be queried upon, the query module 230, in the Step 330, generates a simple query for each processed natural language description contained in the one or more processed natural language descriptions 225 and queries the database 120 more than one time, i.e., with more than one simple query 235. Accordingly, more than one results set 237 is returned. Each results set 237 comprises the results of querying the database 120 on one of these natural language descriptions.

Continuing with the method 300, the query module 230 aggregates the one or more results in all of the results set(s) 237 for all queries 235 and forwards the aggregated results set(s) 237 to the query results processing module 240. In the exemplary embodiment in which the query module 230 also receives the respective similarity scores for the results in the results set(s) 237, the query module 230 also forwards the respective similarity scores to the query results processing module 240.

In an exemplary embodiment, the query results processing module 240 processes the results set(s) 237 by performing exemplary sub-steps 340A through 340C in the Step 340 illustrated in FIG. 3. In this exemplary embodiment, after receiving the results set(s) 237, the query results processing module 240 identifies, for each result in the results set(s) 237, the respective similarity score. If appropriate to the scoring formula used, the query results processing module 240 discards any returned result in the results set(s) 237 that has a similarity score that is below a predetermined threshold similarity score.

The query results processing module 240 then determines whether there are enough results in the results set(s) 237 remaining after the sub-step 340A to create a calculated health-related rating. If the number of results remaining in the results set(s) 237 is greater than or equal to a predetermined number, sub-step 340B, e.g., a predetermined confidence threshold, the query results processing module 240 determines that there is a sufficient number of results remaining in the results set(s) 237, and the method 300 continues to a sub-step 340C. In the sub-step 340C, the query results processing module 240 retrieves the assigned health-related rating for each respective result remaining in the results set(s) 237 and passes the remaining assigned health-related ratings for all results remaining in the results set(s) 237 as the assigned numeric health-related ratings 245 to the rating module 260.

Otherwise, if the number of results remaining in the results set(s) 237 after the sub-step 340B is less than the predetermined number in the sub-step 340B, the method 300 continues to a Step 350, in which the application 200, 200′ displays a message that the health-related rating of the food item cannot be calculated, and the method 300 ends in a Step 360. It is desirable that there be more than one result having an acceptable similarity score to reach a level of confidence in the health-related rating of the food item. It is contemplated, however, that a few or even one result may be enough if the similarity score(s) are high or the matches are exact.

The rating module 260 receives the one or more assigned health-related ratings 245 and their respective similarity scores (in relevant embodiments) from the query results processing module 240 and, using these ratings 245, calculates a single numeric rating 265 in the Step 340. If necessary or desired, the rating module 260 normalizes any of the one or more assigned health-related ratings 245 to a scale, e.g., 1-10, prior to calculating the single numeric rating 265. In one exemplary embodiment, the rating module 260 averages the one or more assigned health-related ratings 245 to calculate the single numeric rating 265. In another exemplary embodiment, the rating module 260 calculates a weighted-average of the ratings 245 to yield the single numeric rating 265. The weights for each of the ratings 245 are their respective similarity scores.

In an exemplary embodiment of the rating module 260, the weights may be optionally adjusted or boosted based on the type of the one or more processed natural language descriptions 225 used in forming the one or more queries 235 and/or the type of the field in the database 120 queried against. In a first exemplary implementation of this exemplary embodiment, if a record in the results set(s) 237 is the result of a query based on a processed natural language description of a certain type queried against the field of the database 120 of the same type, the similarity score for such result may be boosted by doubling it or by increasing it by another desired factor (“boosting factor”). For example, if a record in the results set(s) 237 is the result of a query based on a processed natural language description of a name queried against the Name field of the database 120, the similarity score for such result may be boosted by doubling it or by increasing it by another desired factor. In a second exemplary implementation of this exemplary embodiment, if a record in the results set(s) 237 is the result of a query based on a processed natural language description of any type queried against a field of the database 120 of one specific type, the similarity score for such result may be boosted by doubling it or by increasing it by another desired boosting factor. For example, if a record in the results set(s) 237 is the result of a query based on a processed natural language description of any type (e.g., name, description, category, restaurant, cuisine, etc.) queried against the Name field of the database 120, the similarity score for such result may be boosted by 1.5 or by increasing it by another desired boosting factor. In a third exemplary implementation of this exemplary embodiment, if a record in the results set(s) 237 is the result of a query based on a word-based n-gram (a type of processed natural language description), the similarity score for such result may be boosted by doubling it or by increasing it by another desired boosting factor. It is contemplated that the similarity scores may be boosted in the query results processing module 240 prior to being passed to the rating module 260. In a fourth exemplary implementation of this exemplary embodiment, if a record in the results set(s) 237 is the result of a query based on a processed natural language description of a certain type queried against any field of the database 120, the similarity score for such result may be boosted by 1.5 or by another boosting factor. For example, if a record in the results set(s) 237 is the result of a query based on a processed natural language description of a name queried against any field of the database 120, e.g., Name, Description, etc., the similarity score for such result may be boosted by 1.5 or another boosting factor.

The rating module 260 passes the calculated rating 265 to the output module 270 in the Step 340. The output module 270 outputs the calculated rating 265 in an output 275, Step 350. When the method 300 is performed by the software application 200, the output module 270 transmits the output 275 to the network interface 117, which transmits the output 275 across the network 140 to the mobile computer system 130 or to the personal computer system 150, which displays the calculated rating 265 received via the network interface 137, 157 on the output interface 139 or 159, or to the server 160, which stores the results on the internal storage device 165 in the Step 350. When the method 300 is performed by the software application 200′, the output module 270 of the software application 200′ transmits the output 275 to the output interface 139, 159 for displaying the calculated rating 265 (when executed on the computer system 130, 150) or to the internal storage device 165 (when executed on the server 160).

It is to be understood that the rating 265 is calculated without the user being required to identify the breakdown of ingredients in a food item, identify the types of certain ingredients in the food item, provide measurements for each ingredient in the food item, identify the portion size of the food item, or even to have access to the food item at the time the request 205 is transmitted. Thus, the application 200, 200′ provides a user a flexible platform for having the health-related rating of a food item calculated.

Because the calculated rating 265 may be based on a combination or average of ratings in the database 120, it is to be understood that there is possibility for somewhat inaccurate ratings, i.e., the calculated rating 265 may have an associated margin of error. It is possible that a user wanting to compare multiple food items may be mislead by the specificity of a value of the calculated numeric rating 265 because of the margin of error. For example, if the rating module 260 is configured to calculate the numeric rating 265 to lie within a range of 1 to 10, a user may infer from comparing a rating 265 for a first food to a rating 265 for a second food that one is materially more healthful than the other. For example, suppose the rating 265 for a first food item is 7.0, and the rating 265 for a second food item is 7.5. A user may incorrectly conclude that the second food item is more healthful than the first, even though inaccuracies resulting from querying the database 120 and processing the results set(s) 237 may have influenced the final ratings 265, i.e., the ratings are within the margin of error of each other. It might be possible that the true rating for the first food item is 7.3 and that of the second food item is 7.2. Alternatively, it is possible that a user may be mislead by a numeric rating 265 simply because he does not understand what information the numeric rating 265 conveys. For example, the user may not understand whether a rating 265 of 7.0 is a good, average, or low rating, compared to other foods. Thus, displaying the numeric rating 265 may be appropriate for users who understand the margin of error included with a rating 265. Those users, who do not, may benefit from a graphical representation of the rating 265.

In an exemplary embodiment, the applications 200 and 200′ convert the numeric rating 265 included in the output 275 to a visual indication. Various ways of graphically displaying the rating 265 are contemplated. In one exemplary embodiment, the rating 265 may be displayed as a red, yellow, or green circle. Red indicates that the food item described in the one or more natural language descriptions 215 is not healthful. Green indicates that the food item described in the one or more natural language descriptions 215 is healthful. Yellow indicates that the food item described in the one or more natural language descriptions 215 is between both. In another exemplary embodiment, the rating 265 may be displayed as an “x”, “?”, and a checkmark. The “x” indicates that the food item described in the one or more natural language descriptions 215 is not healthful. The checkmark indicates that the food item described in the one or more natural language descriptions 215 is healthful. The “?” indicates that the food item described in the one or more natural language descriptions 215 is between both. Other graphical representations may use a star system (more stars indicating a more healthful food item), thumbs up/thumbs down, or different shapes.

In an exemplary embodiment, the range of possible numeric ratings is evenly split so that the displayed graphical representations correspond to ranges of equal sizes. For example, a rating of 0 to 3.33 will result in a red circle being displayed by the output interface 139, 159; a rating of 3.34 to 6.66 will result in a yellow circle being displayed by the output interface 139, 159; and a rating of 6.67 to 10.00 will result in a green circle being displayed by the output interface 139, 159. It is to be understood that in other exemplary embodiments the numeric scale is not evenly split. For example, all ratings 265 from 5.01 to 10.00 may be green; values below 2.00 may be red; and all values from 2.00 to 5.00 may be yellow.

The values of ranges may be adjusted over time, especially if more indexed food items are added to the database 120. The food items added to the database 120 may be rated by multiple raters who administer the database 120. The raters may scrutinize different food items differently. Thus, the adjustments to the ranges can be considered a way to normalize the different preferences and biases of the raters. A method for setting these splits is to use a standard list of foods that have a general consensus on where they should be rated on a scale. A rater's scale is then normalized to the general consensus scale.

Various exemplary sources of the one or more inputted natural language descriptions 215 are contemplated. The mobile computer system 130 or the personal computer system 150 provides a software interface to the application 200 or 200′ to a user of the mobile computer system 130 or the personal computer system 150 to input the one or more inputted natural language descriptions 215. Additionally, the server 160 may provide the one or more inputted natural language descriptions 215, which are stored on the internal storage medium 165, to the application 200 or 200′ for rating.

When the method 300 is performed by the software application 200, the software interface may take the form of a web form that is rendered in a web browser executed on the mobile computer system 130 or the personal computer system 150. The software interface receives the request 205 provided by the user using the input interface 132, 152 and forwards it to the application 200, as described above. The software interface receives the output 275 from the server 110 via the network 140 and displays it in the output interface 139, 159, as described above.

When the method 300 is performed by the software application 200′, the mobile computer system 130 or the personal computer system 150 provides a software interface to the application 200′ to a user of the mobile computer system 130 or the personal computer system 150. The software interface may take the form of a software form that is part of the application 200′. The software interface receives the request 205 provided by the user using the input interface 132, 152 and displays the output 275 in the output interface 139, 159.

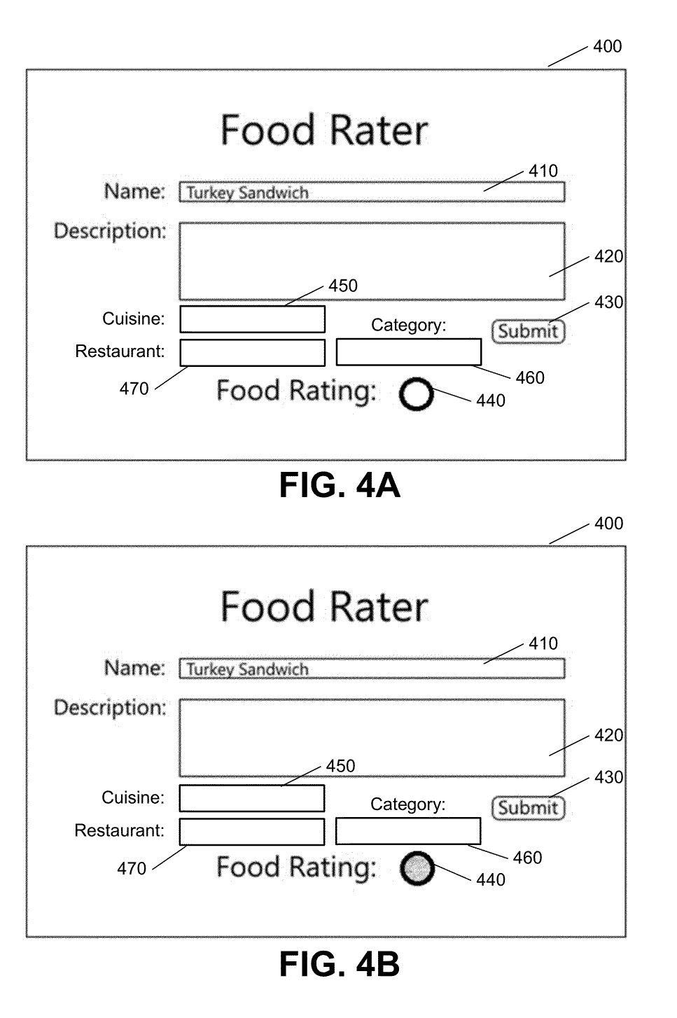

An example of the form used to interface with either application 200, 200′ is illustrated in FIG. 4A and generally designated as 400, in accordance with an exemplary embodiment of the present invention. The form 400 comprises a text box 410 for receiving inputted text that is a natural language description of a name of a food item and a text box 420 for receiving inputted text that is a natural language description of a description of the food item. In the exemplary embodiment illustrated in FIG. 4A, the user has entered “Turkey Sandwich” into the text box 410, thereby identifying the food item of interest by the name, “Turkey Sandwich.”

The form 400 further comprises a submit button 430 for commanding the form 400 to transmit the text currently appearing in the text boxes 410 and 420 to the input module 210. The form 400 also comprises an element 440 for indicating the calculated health-related rating 265 of a food item named in the text box 410 and/or described in the text box 420. The element 440 is not shown colored in FIG. 4A as the submit button 430 has not been selected yet.

The goal of visualizing the final result is to associate a rating with a food item. An example of displaying a calculated rating 265 in the form 400 is illustrated in FIG. 4B, in accordance with an exemplary embodiment of the present invention. In FIG. 4B, the element 440 has been colored in to indicate the health-related rating of a food item identified in the text box 410 by the name, “Turkey Sandwich.”

As illustrated in FIGS. 4A and 4B, the form 400 comprises two text boxes 410 and 420. It is to be understood that the form 400 is not limited to including both text boxes 410 and 420 or only two text boxes 410 and 420. The form 400 may further include a text box 450 for receiving a natural language description of the cuisine of the named or described food item and/or text box 460 for receiving a category (e.g., “appetizer,” “dessert,” etc.) of the named or described food item. The form 400 may also include a text box 470 for receiving a natural language description identifying a restaurant where the food item is offered. In an exemplary embodiment, the applications 200 and 200′ do not require that input be supplied to both text boxes 410 and 420. Text may be inputted into only one of text boxes 410 and 420. Furthermore, it is to be understood that entry of text into the text boxes 450, 460, and 470 is optional.

To use the form 400, the user inputs text into the text box 410 and/or 420 and optionally into any of the text boxes 450, 460, and 470 and selects the submit button 430. The form 400 transmits the text in the text boxes 410 and/or 420 and, when used, the text boxes 450, 460, and/or 470 to the input module 210 of the application 200, 200′ as the one or more inputted natural language descriptions 215 in the request 205, as described herein, for rating the food item corresponding to the one or more natural language descriptions 215, as described herein. After the application 200, 200′ has rated the food item, and the form 400 of the mobile computer system 130 or the personal computer system 150 has received the calculated rating 265 in the Step 350 in the output 275 from the output module 270, the mobile computer system 130 or the personal computer system 150 displays the rating 265 using element 440 in the form 400. The element 440 may display the calculated rating 265 using any of the indicators described herein, such as colored circles, stars, etc.

The form 400 and the applications 200 and 200′ do not require that the user name and describe a food item in a specific way. Instead, the user may input one or more natural language descriptions into the text boxes 410 and 420 just as if he were ordering food in an establishment. For example, the natural language description for the name of a food item may be “Turkey Sandwich,” and the natural language description of a description of the food item may be “turkey, lettuce, tomato, and mayo on a roll.” The description of the food item may provide further information regarding the ingredients of the food item, e.g., “turkey, lettuce, tomato, and mayo on a roll,” how the food item or its ingredients are prepared, e.g., smoked turkey, etc. The user may input the text for the text boxes 410 or 420 by typing it, or the mobile computer system 130 or the personal computer system 150 may fill in the text using speech-to-text software to process the user's speech and convert it to text for the text boxes 410 and 420 or transmit it to the applications 200 and 200′ directly. It is to be understood that how the request 205 is sourced is not limited to any one technology.

The software interface may also take the form of a special form provided by the application 200, 200′, which special form comprises fields for inputting the natural language descriptions of the food items on the menu of a restaurant in a format commonly found on menus. The special form may be used in a similar way to the form 400 described herein by an employee of the restaurant using the mobile computer system 130 or the personal computer system 150 or any other person using the mobile computer system 130 or the personal computer system 150. After the menu is inputted, the special form transmits a request for each food item in the menu to be rated. When the ratings are complete, the software application 200, 200′ may insert the ratings into the menu for each food item listed thereon and transmit the rated (annotated) menu to the internal storage device 165 of the server 160 for storage thereon or to the internal storage device 115 of the server 110 for storage thereon. The server 160 may be provided by a web hosting service for hosting the restaurant's annotated menu or by a third-party menu aggregator for hosting menus for a plurality of restaurants, including this rated menu.

As described, the server 160 may provide the one or more natural language descriptions 215, which are stored on the internal storage medium 165, to the application 200 or 200′ for rating. In an exemplary embodiment, the one or more natural language descriptions 215 may be contained within an electronic menu stored on the internal storage medium 165. The information in the menus may be rated by the server 160 itself, if the server 160 is executing the application 200′, or by the server 110, if the server 110 is executing the application 200. If the server 110 rates the menus, they may be retrieved by the application 200 on the server 110 directly from the web server 160 or pushed by the server 160 to the application 200 on the server 110 for rating, as described herein. In an exemplary embodiment, the server 160 provides an API by which the application 200, 200′ requests the menu information in a known format. In addition, the server 160 may provide a uniform data structure which allows for extraction of text corresponding to each food item individually, obtaining at least one natural language description for each food item, such as a name or a description, and optionally other information such as a category, cuisine, etc.

The server 160 may be a server hosting the restaurant's website or it may be a server that hosts a website that is operated by a third party that aggregates menus of a plurality of restaurants. The information in the menu may be (1) rated by the server 160 itself if the server 160 is executing the application 200′, (2) retrieved and rated by the application 200 on the server 110 directly from the web server 160, or (3) downloaded from the server 160 from an internet-connected device operated by an employee of the restaurant or any other person, such as the mobile computer system 130 or the personal computer system 150, and then electronically provided to the application 200, 200′ for rating, as described herein. The input module 210 in the application 200, 200′ is configured to electronically receive the menu, extract the one or more natural language descriptions of the food items in the menu, and request the one or more natural language descriptions for each food item, one by one, to be rated pursuant to the method 300, as described herein. More specifically, when the application 200, 200′ processes the one or more natural language descriptions in a menu, each one or more natural language descriptions for a food item in the menu is identified separately in the Step 320 by the input processing module 220 and is then processed separately by the remaining steps of the method 300 and modules of the application 200, 200′ to calculate the health-related rating for the food item using the one or more natural language descriptions for the food item.

In one exemplary embodiment, the application 200, 200′ provides the server 160 with the ratings so that the server 160 can update the menu stored on the internal storage device 165 with the calculated ratings for the food items. Users may then browse to the restaurant's website or to the website operated by the third-party aggregator, either of which websites is hosted by the server 160, to view the menu annotated with the ratings. In another exemplary embodiment, the application 200, 200′ stores the rated menu on the internal storage device 115 of the server 110 for hosting in a web page. Users can then browse to this web page to view the restaurant's menu annotated with the ratings.

The applications 200 and 200′ are configured for processing the one or more natural language descriptions on demand for presenting the calculated rating 265 to the user in real time. When a user requests a rating on a food item he has submitted through the form 400, the application 200, 200′ rates the food item in real time and returns the rating 265 in the output 275 for display in real time in the form 400. In an exemplary embodiment, the browser on the mobile computer system 130 or the personal computer system 150, in embodiments in which the application 200 is used, or the application 200′ itself may include a cache for storing a calculated rating in case the user requests that the same food item be rated again within a predetermined amount of time, e.g., ten minutes. The cache prevents repeated, unnecessary querying of the database 120.

When the source of the one or more natural language descriptions is a restaurant menu, it may be desirable to rate the food items and store the entire menu with the calculated ratings for later retrieval. Rating menu food items in real time may take time, e.g., seconds. Users may be less willing to request that a restaurant menu be rated if they feel there is a long wait time for the ratings calculations. Thus, in an exemplary embodiment, the menu stored on the internal storage device 165 is rated and stored by the server 110 or 160 for later access by users. In another exemplary embodiment, the menu requested to be rated by a restaurant using the specialized form is rated using techniques described herein, updated, and stored by the server 110 or 160 for later access. When a user browses to the website hosted by the server 110 or 160, the user will be able to browse the ratings in the annotated menu. By storing the rated menus, the burden placed on the database 120 from large numbers of queries is reduced. Furthermore, menus tend to change slowly, again making them good candidates for persistent storage. Third-party aggregators may also provide methods of detecting menus which have changed, allowing for minimal processing by the application 200, 200′ and preventing or reducing further load on the database 120.

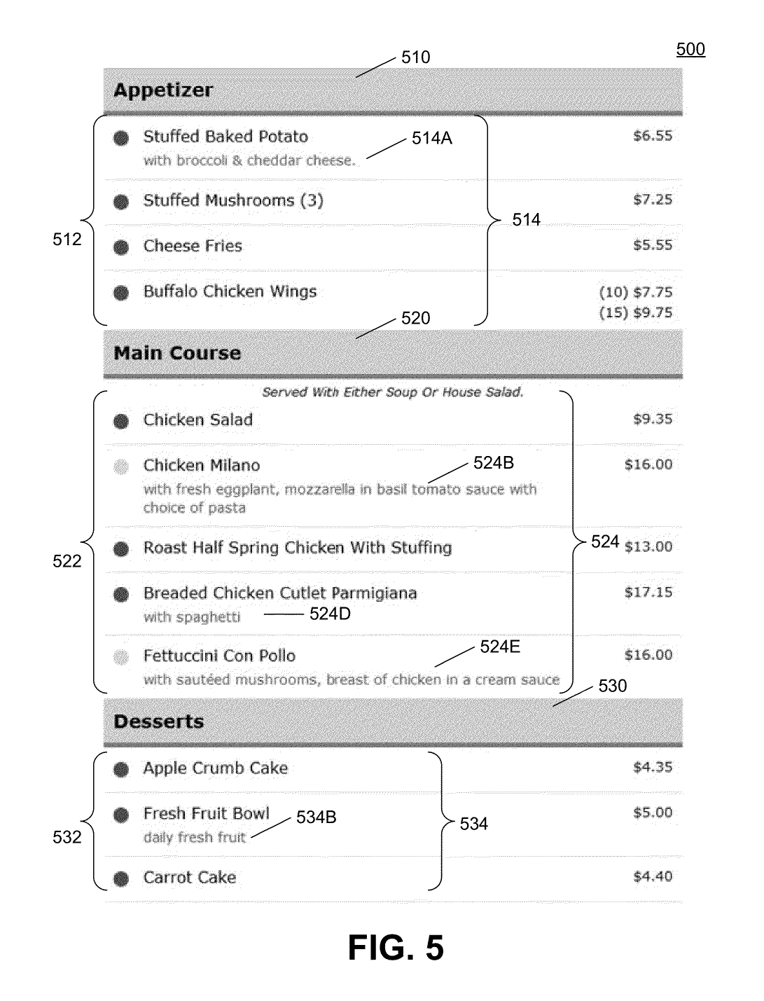

Referring now to FIG. 5, there is illustrated an exemplary embodiment of a menu, generally designated as 500, in accordance with an exemplary embodiment of the present invention. The menu 500 is an example of a menu that has had its constituent food items rated by the application 200, 200′ per the method 300 and has been annotated with indications of such ratings. The menu 500 may be provided in the website hosted by the server 160 or in the website hosted by the server 110.

The menu 500 comprises three categories of food items: appetizer 510, main course 520, and desserts 530. The appetizer 510 category comprises four food items 514, each identified by its name. The first food item in 514 further includes a description 514A, “with broccoli & cheddar cheese.” The description 514A identifies further ingredients of the first food item, but does not identify all ingredients, as it does not list “potato.” The ingredient, “potato,” instead is identified by the name of the first food item 514 (“Stuffed Baked Potato”).

The main course 520 category comprises five food items 524, each also identified by its name. The second, fourth, and fifth food items 524 are each provided with respective descriptions 524B, 524D, and 524E. Finally, the desserts 530 category comprises three food items 534, the second of which is provided with a description 534B, “daily fresh fruit.” As evident, the description “daily fresh fruit,” provides a further description of the “Fresh Fruit Bowl” item name but does not further identify ingredients.

As illustrated in FIG. 5, the menu 500 is provided with calculated health-related ratings 512, 522, and 532 for each respective food item 514, 524, and 534 to provide a relative indication of the healthfulness of the food items 514, 524, and 534.

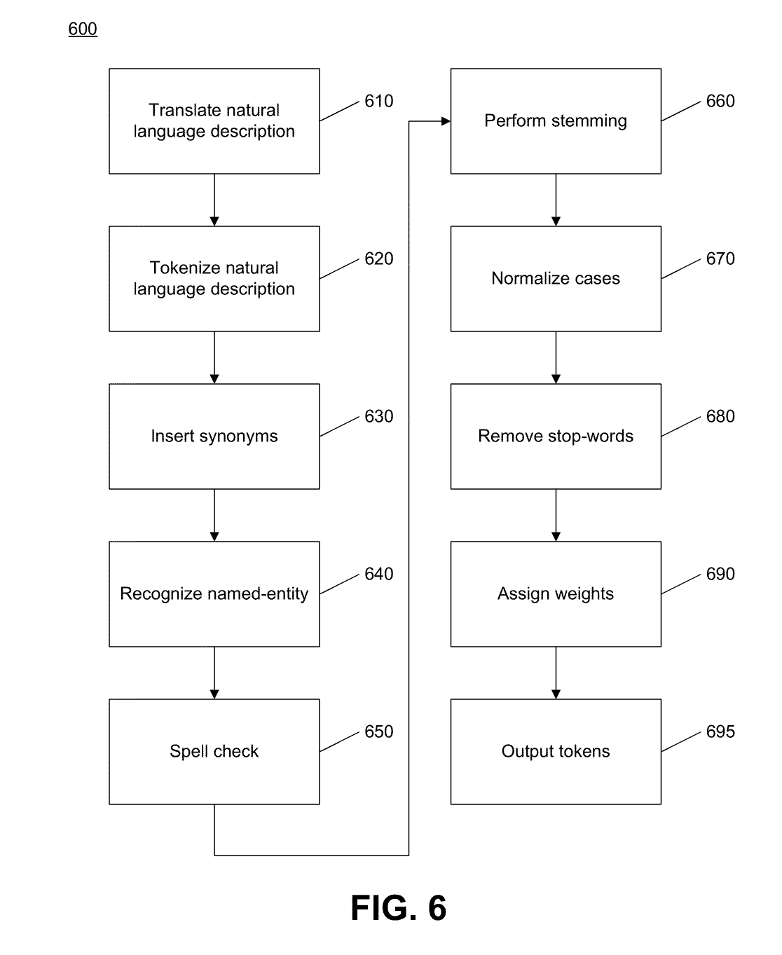

Referring now to FIG. 6, there is illustrated an exemplary method, generally designated as 600, of preparing an inputted natural language description to generate a processed natural language description, in accordance with an exemplary embodiment of the present invention. In an exemplary embodiment of the method 300 and the application 200 or 200′, the steps of the method 600 are performed by the input processing module 220 of the application 200, 200′ when performing the Step 320 of the method 300. The input into the method 600 is the one or more inputted natural language descriptions 215, and the output from the method 600 is the one or more processed natural language descriptions 225, e.g., one or more tokens, as described below.

The method 600 begins with a Step 610 of translating the one or more inputted natural language descriptions 215 to the language supported by the database 120. The Step 610 is optional or not performed if the one or more natural language descriptions are in the language supported by the database 120.

The method 600 continues to a Step 620 of tokenizing the one or more inputted natural language descriptions 215 by splitting them into separate tokens. At the most basic level, each word of the one or more inputted natural language descriptions 215 could become a single token by splitting the one or more inputted natural language descriptions 215 at a space character(s) in the one or more inputted natural language descriptions 215 (assuming that more than one word forms the description), although other characters may also denote separate words, such as a hyphen, in combination or alone.

Word based n-grams are also helpful in boosting query quality and are formed by splitting words of the description 215 into tokens and then concatenating the tokens into a single token, supplementing the separate tokens. For example, the description “fish sticks” may become the following three tokens: “fish”, “sticks”, and “fish sticks”. Words surrounded by quotation marks may become a single token as well. For example, the natural language description 215 of a name of a food item could be “‘Roast Half Spring Chicken’ With Stuffing”. In this case ‘Roast Half Spring Chicken’ is surrounded by quotation marks, and one of the many tokens (“Roast”, “Half,” “Spring Chicken”, etc.) may also be “Roast Half Spring Chicken”.

The method 600 continues to a Step 630 of inserting synonyms for the tokens. An example is adding the token “hoagie” when the description 215 includes “submarine” or “hero.” The insertion, however, may also add more general descriptors for tokens in the description 215. For example, if the description 215 includes “cod”, “fish” may be added as it is a genus of “cod.” Another example is adding “cookie” if the description 215 includes “Oreo®.”

Processing continues to a Step 640, in which the input processing module 220 determines whether the description 215 includes a named-entity that is a combination of two or more tokens. If so, the two or more tokens are combined back to the named-entity or are discarded if the result would be duplication. For example, the description “hot dog” results in the following tokens in the Step 610: “hot dog”, “hot”, and “dog”. In the Step 640, the input processing module 220 recognizes that “hot dog” is a named entity. Thus, the tokens, “hot” and “dog,” have no meaning other than when combined. Thus, these tokens are combined and the combination “hot dog” is discarded because it is redundant, as “hot dog” is already an identified token.

The method 600 continues to a Step 650 to check the spelling of the tokens. In this step, the input processing module 220 replaces or adds words or tokens with alternate spellings in order to have uniform spelling, even if that spelling is incorrect or is inconsistent with the token. Since the final query is never shared with the user, these discrepancies are not a concern. The query 235 can be formulated to overcome spelling differences not corrected in this process, using a special type of query, which is called a fuzzy query, which allow for a specified amount of spelling differences between words or tokens.

In a Step 660, the input processing module 220 reduces the tokens to their stems. For example, “crackers” is reduced to “cracker”, or “fishes” is reduced to “fish.” (Even though “fishes” is not a word, users may input it to be rated.) The stem may either replace or supplement the original token. In a Step 670, the characters may all be converted to a common case. For example, “Fish” and “fiSh” may be converted to “fish.” In a Step 680, the input processing module 220 removes conjunctions, articles, and other stop words. In a Step 690, the input processing module 220 assigns weights to the tokens. Emphasizing certain words or tokens may also boost query quality. For example, when given multiple inputs from the form 400 or multiple pieces of data from the menu 500, some items such as the name of the food item may be considered more important and can be assigned a weight greater than the default weight, resulting in a boost to the similarity score of a query that matches the dish name, versus one that matches other parts.

Finally, in a Step 695, the input processing module 220 outputs the final set of tokens to the query module 230. The final set of tokens forms the one or more processed natural language descriptions 225 that form the basis of the query 235. The method 600 is thereby complete, and the remainder of the method 300 takes over.

As noted above, in an exemplary embodiment of the method 300 and the application 200 or 200′, the steps of the method 600 are performed by the input processing module 220 of the application 200, 200′ when performing the Step 320 of the method 300. In another exemplary embodiment, the steps of the method 600 are also performed by the server 110 when indexing food items in the database 120. Thus, the steps of the method 600 may be performed when indexing the records of food items in the database 120 and when processing the one or more inputted natural language descriptions 215 in preparation for querying the database 120 to retrieve health-related ratings.

Although the method 600 is illustrated as including nine steps 610 through 690, it is to be understood that all of these steps are not required. In an exemplary embodiment, only the Step 620 is performed. The functionality of tokenization in the Step 620 may be the most desirable functionality of the method 600 when preparing the processed natural language description. In another exemplary embodiment, only the Steps 650 and 680 are performed. In yet another exemplary embodiment, only the Steps 650, 680, and 690 are performed.

Furthermore, although the steps of the method 600 are illustrated in a particular order, it is to be understood that the method 600 is not limited to performing these steps in the illustrated order. For example, the Step 670 may be performed before the Step 630. Or, the Step 650 may be performed before the Step 630.

In an exemplary embodiment, the database 120 is a document-oriented database in which each document is a single record that comprises the one or more fields described herein, e.g., Name, Description, Category, Restaurant, Cuisine, etc., and a unique ID. The index is generated by running the fields of the records through the process 600 to identify the tokens in the fields of the records. The tokens are stored in a separate index called an “inverted index”, with each token knowing which documents (identified by the IDs) contain the token and in what field in the document the token appears. More than one document may contain a token, hence the use of similarity scores.

For example, more than one record (or more than one field in the records) in the database 120 may contain the token, “fish.” However, there is only one entry for this token in the index. This makes searching highly efficient since a token identified by the input processing module 220 is matched exactly against an indexed token (with the exception of fuzzy queries, which use more computer resources and take longer).

### EXAMPLES

Suppose the form 400 comprising the text boxes 410, 420, and 450 is presented to a user. The user enters “Stuffed Baked Potato” into the text box 410, “with broccoli” into the text box 420, and “American” into the text box 450. These natural language descriptions 215 are received by the input module 210 as the request 205 in the Step 310. The input module 210 strips these natural language descriptions 215 from the request 205 and passes them to the input processing module 220. In the Step 320, the input processing module 220 employing exemplary method 300 outputs the following tokens in the inputted natural language descriptions 215 as processed natural language descriptions 225:

Name: “stuffed”, “baked”, “potato”, “stuffed baked”, “baked potato”

Description: “broccoli”, “with broccoli”

Cuisine: “american”

To arrive at these processed natural language descriptions (tokens) 225, the input processing module 220 performs Step 670 (case normalization), Step 620 (tokenizing on “ ” (space) and creating word based n-grams, with a maximum of two words), and Step 680 (ignoring stop words, such as “with”, which is removed as a separate token). In the Step 330, the query module 230 queries the database 120 based on the processed natural language descriptions 225.

Assuming that the database 120 is indexed according to Category, Name, and Description fields, the query module 230 formats the query 235 as a complex query in one of the following ways. (It is understood that descriptions below of boosting relates to the boosting performed in the rating module 260 or the query results processing module 240. In the exemplary formats below for the complex query 235, the complex query 235 is formed by taking each token 225 and placing that token into appropriate simple queries in the places identified by brackets. Simple queries are joined by an “OR” where there are multiple tokens.)

### Example 1

Possible Query Format 1 (match fields exactly; is highly dependent on structure of indexed foods and form):
Search for all indexed foods where:
1. Has {Token from Name} in Name field OR
2. Has {Token from Description} in Description field

Using the exemplary tokens identified above, Query 1 appears as:
Search for all indexed foods where:
1. Has “stuffed” in Name field OR “baked” in Name field OR “potato” in Name field OR “stuffed baked” in Name field OR “baked potato” in Name field OR
2. Has “broccoli” in Description field OR “with broccoli” in Description field.

### Example 2

Possible Query Format 2 (match tokens anywhere; like the first, but does not assume user will express food in the same way as indexed foods):
Search for all indexed foods where:
1. Has {Token from Name} in Name field OR
2. Has {Token from Description} in Description field OR
3. Has {Token from Name} in Description field OR
4. Has {Token from Description} in Name field

Using the exemplary tokens identified above, Query 2 appears as:
Search for all indexed foods where:
1. Has “stuffed” in Name field OR “baked” in Name field OR “potato” in Name field OR “stuffed baked” in Name field OR “baked potato” in Name field OR
2. Has “broccoli” in Description field OR “with broccoli” in Description field OR
3. Has “stuffed” in Description field OR “baked” in Description field OR “potato” in Description field OR “stuffed baked” in Description field OR “baked potato” in Description field OR
4. Has “broccoli” in Name field OR “with broccoli” in Name field.

### Example 3

Possible Query Format 3 (match tokens anywhere and weights like field matches differently; like Query Format 2, but gives a boost to similarity score when the fields match):
Search for all indexed foods where:
1. Has {Token from Name} in Name field and boost matches by a factor of 2 OR
2. Has {Token from Description} in Description field and boost matches by a factor of 2 OR
3. Has {Token from Name} in Description field OR
4. Has {Token from Description} in Name field

Using the exemplary tokens identified above, Query 3 appears the same as Query 2 with relevant boosting factors used in accordance with the Query 3 format.

### Example 4

Possible Query Format 4 (matches tokens anywhere and weights different token matches differently; like Query Format 2, but gives a boost to certain natural language descriptions, in this case the natural language description for the name of the food item):
Search for all indexed foods where:
1. Has {Token from Name} in Name field and boost matches by a factor of 2 OR
2. Has {Token from Description} in Description field OR
3. Has {Token from Name} in Description field and boost matches by a factor of 2 OR
4. Has {Token from Description} in Name field

Using the exemplary tokens identified above, Query 4 appears the same as Query 2 with relevant boosting factors used in accordance with the Query 4 format.

### Example 5

Possible Query Format 5 (matches tokens anywhere, including in fields that do not have a corresponding natural language description in the one or more natural language descriptions 215, and weights different token matches differently; like Query Format 2, but gives a boost to certain natural language descriptions, in this case the natural language description for the name of the food item):
Search for all indexed foods where:
1. Has {Token from Name} in Name field and boost matches by a factor of 2 OR
2. Has {Token from Description} in Description field OR
3. Has {Token from Name} in Description field and boost matches by a factor of 2 OR
4. Has {Token from Description} in Name field OR
5. Has {Token from Name} in Category field and boost matches by a factor of 2 OR
6. Has {Token from Description} in Category field

Using the exemplary tokens identified above, Query 5 appears the same as Query 2 with relevant boosting factors used in accordance with the Query 5 format and additional query criteria relating to the Category field.

### Example 6

Given more tokens, or fields on either the user form or indexed foods, the complexity of the query 235 grows. To combat this, an additional field is added to all indexed foods called “Main Data” (the master string field), with the value of “{Value of Category} {Value of Name} {Value of Description}”.

Possible Query Format 6 (all matches will occur in “Main Data”; structure of user form and indexed food does not matter anymore because all relevant data is in “Main Data”; matches to tokens originating from the Name input are boosted):
Search for all indexed foods where:
1. Has {Token from Name} in “Main Data” field and boost matches by a factor of 2 OR
2. Has {Token from Description} in “Main Data” field

Using the exemplary tokens identified above, Query 6 appears as:
Search for all indexed foods where:
1. Has “stuffed” in Main Data field OR “baked” in Main Data field OR “potato” in Main Data field OR “stuffed baked” in Main Data field OR “baked potato” in Main Data field and boost matches by a factor of 2 OR
2. Has “broccoli” in Main Data field OR “with broccoli” in Main Data field

Further boosting can also be done based on other criteria (other than based on the user form input the token originated from). For example, n-gram tokens can be boosted by a factor of 1.5. If done in combination with boosting tokens originating from the Name input, then n-gram tokens originating from the Name input would be boosted by a factor of 3 (2*1.5), and n-gram tokens from Description would just be boosted by 1.5.

The “Main Data” field may be used exclusively when the application 200, 200′ is not concerned with what field the match occurs in.

### Example 7

If boosting on what indexed food field the match occurred in is desired, querying on the Main Data field would not provide enough information to allow such boosting. Thus, querying on Main Data may be combined with querying on the structured fields.

Possible Query Format 7:
Search for all indexed foods where:
1. Has {Token from Name} in “Main Data” field and boost matches by a factor of 2 OR
2. Has {Token from Description} in “Main Data” field OR
3. Has {Cuisine Name} in “Cuisine Name” field and boost matches by a factor of 1.5

Using the exemplary tokens identified above, Query 7 appears as:
Search for all indexed foods where:
1. Has “stuffed” in Main Data field OR “baked” in Main Data field OR “potato” in Main Data field OR “stuffed baked” in Main Data field OR “baked potato” in Main Data field and boost matches by a factor of 2 OR
2. Has “broccoli” in Main Data field OR “with broccoli” in Main Data field
3. Has “american” in Cuisine field and boost matches by a factor of 1.5

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

What is claimed is:

1. A system for calculating a health-related rating of a food item, comprising:
a database comprising a plurality of records, each record comprising one or more natural language descriptions of a respective food item and a health-related rating of the respective food item; and
a computer system comprising:
an input module configured for receiving an input comprising a request to calculate a health-related rating for a requested food item, the input further comprising one or more inputted natural language descriptions of the requested food item;
an input processing module configured for processing the one or more inputted natural language descriptions to generate one or more processed natural language descriptions;
a query module configured for querying the database based on the one or more processed natural language descriptions; and
a rating module configured for:
receiving a results set from the database in response to the querying; and
calculating the health-related rating for the requested food item based on the results set.

2. The system of claim 1, wherein the results set comprises one or more of the plurality of records indexed by respective ones of the one or more processed natural language descriptions, each of the one or more of the plurality of records comprising a respective assigned health-related rating, and wherein the rating module is configured for calculating the health-related rating for the requested food item based on the respective assigned health-related rating of each of the one or more of the plurality of records in the results set.

3. The system of claim 2, wherein the results set further comprises a respective similarity score for each of the one or more of the plurality of records in the results set, and wherein the rating module is configured for calculating the health-related rating for the requested food item based on the respective assigned health-related rating and the respective similarity score of each of the one or more of the plurality of records in the results set.

4. The system of claim 3, wherein the input further comprises an inputted name of the food item, and each record further comprises a name of the respective food, and wherein the rating module is further configured to boost the similarity score of any record in the results set in which the name in the any record matches the inputted name.

5. The system of claim 1, wherein:
the input processing module is configured for processing the one or more inputted natural language descriptions to generate one or more processed tokens; and
the query module is configured for querying the database based on the one or more processed tokens.

6. The system of claim 5, wherein the input processing module is further configured for processing the one or more inputted natural language descriptions to generate the one or more processed tokens by splitting the one or more inputted natural language descriptions at one or more space characters in the one or more inputted natural language descriptions.

7. The system of claim 5, wherein the input processing module is further configured for processing the one or more inputted natural language descriptions to generate the one or more processed tokens by:
splitting the one or more inputted natural language descriptions at one or more space characters in the one or more inputted natural language descriptions to generate one or more pre-processed tokens; and
removing stop words from the one or more pre-processed tokens to generate the one or more processed tokens.

8. The system of claim 5, wherein the input processing module is further configured for processing the one or more inputted natural language descriptions to generate the one or more processed tokens by:
splitting the one or more inputted natural language descriptions at one or more space characters in the one or more inputted natural language descriptions to generate one or more pre-processed tokens;
removing stop words from the one or more pre-processed tokens to generate one or more intermediate tokens; and
reducing the one or more intermediate tokens to their stems to generate the one or more processed tokens.

9. The system of claim 1,
wherein the computer system further comprises a query results processing module configured for:
receiving the results set from the database in response to the querying;
processing the results set to generate one or more processed results; and
forwarding the one or more processed results to the rating module, and wherein the rating module is configured for:
receiving the one or more processed results from the query results processing module; and
calculating the health-related rating for the requested food item based on the one or more processed results.

10. A method for calculating a health-related rating of a food item, comprising steps of:
receiving an input comprising a request to calculate a health-related rating for a requested food item, the input further comprising one or more inputted natural language descriptions of the requested food item;
processing the one or more inputted natural language descriptions to generate one or more processed natural language descriptions;
querying a database based on the one or more processed natural language descriptions, the database comprising a plurality of records, each record comprising one or more natural language descriptions of a respective food item and a health-related rating of the respective food item;
receiving a results set from the database in response to the querying; and
calculating the health-related rating for the requested food item based on the results set.

11. The method of claim 10, wherein the step of receiving comprises receiving, via a network interface, the input transmitted over a network.

12. The method of claim 10, wherein the step of receiving comprises receiving, via an input module, the input from an input interface.

13. The method of claim 10, wherein the results set comprises one or more of the plurality of records indexed by respective ones of the one or more processed natural language descriptions, each of the one or more of the plurality of records comprising a respective assigned health-related rating, and wherein the step of calculating comprises calculating the health-related rating for the requested food item based on the respective assigned health-related rating of each of the one or more of the plurality of records in the results set.

14. The method of claim 10, wherein the results set further comprises a respective similarity score for each of the one or more of the plurality of records in the results set, and wherein the step of calculating comprises calculating the health-related rating for the requested food item based on the respective assigned health-related rating and the respective similarity score of each of the one or more of the plurality of records in the results set.

15. The method of claim 14, wherein the input further comprises an inputted name of the food item, and each record further comprises a name of the respective food item, and wherein the step of calculating further comprises boosting the similarity score of any record in the results set in which the name in the any record matches the inputted name.

16. The method of claim 10 wherein:
the step of processing comprises processing the one or more inputted natural language descriptions to generate one or more processed tokens; and
the step of querying comprises querying the database based on the one or more processed tokens.

17. The method of claim 16, wherein the step of processing further comprises processing the one or more inputted natural language descriptions to generate the one or more processed tokens by splitting the one or more inputted natural language descriptions at one or more space characters in the one or more inputted natural language descriptions.

18. The method of claim 16, wherein the step of processing further comprises processing the one or more inputted natural language descriptions to generate the one or more processed tokens by:
splitting the one or more inputted natural language descriptions at one or more space characters in the one or more inputted natural language descriptions to generate one or more pre-processed tokens; and
removing stop words from the one or more pre-processed tokens to generate the one or more processed tokens.

19. The method of claim 16, wherein the step of processing further comprises processing the one or more inputted natural language descriptions to generate the one or more processed tokens by:
splitting the one or more inputted natural language descriptions at one or more space characters in the one or more inputted natural language descriptions to generate one or more pre-processed tokens;
removing stop words from the one or more pre-processed tokens to generate one or more intermediate tokens; and
reducing the one or more intermediate tokens to their stems to generate the one or more processed tokens.

20. The method of claim 10, further comprising a step of processing the results set to generate one or more processed results, wherein the step of calculating comprises calculating the health-related rating for the requested food item based on the one or more processed results.

21. A tangible computer-readable medium comprising software instructions stored thereon that when executed by a computer system cause the computer system to carry out steps of:
receiving an input comprising a request to calculate a health-related rating for a requested food item, the input further comprising one or more inputted natural language descriptions of the requested food item;
processing the one or more inputted natural language descriptions to generate one or more processed natural language descriptions;
querying a database based on the one or more processed natural language descriptions, the database comprising a plurality of records, each record comprising one or more natural language descriptions of a respective food item and a health-related rating of the respective food item, the database further comprising an index of the one or more natural language descriptions in each of the plurality of records;
receiving a results set from the database in response to the querying; and
calculating the health-related rating for the requested food item based on the results set.

22. The tangible computer-readable medium of claim 21,
wherein the results set comprises one or more of the plurality of records indexed by respective ones of the one or more processed natural language descriptions, each of the one or more of the plurality of records comprising a respective assigned health-related rating, and
wherein the step of calculating comprises calculating the health-related rating for the requested food item based on the respective assigned health-related rating of each of the one or more of the plurality of records in the results set.

23. The tangible computer-readable medium of claim 21,
wherein the results set further comprises a respective similarity score for each of the one or more of the plurality of records in the results set, and
wherein the step of calculating comprises calculating the health-related rating for the requested food item based on the respective assigned health-related rating and the respective similarity score of each of the one or more of the plurality of records in the results set.

24. The tangible computer-readable medium of claim 23,
wherein the input further comprises an inputted name of the food item, and each record further comprises a name of the respective food item, and
wherein the step of calculating further comprises boosting the similarity score of any record in the results set in which the name in the any record matches the inputted name.

25. The tangible computer-readable medium of claim 21 wherein:
the step of processing comprises processing the one or more inputted natural language descriptions to generate one or more processed tokens; and
the step of querying comprises querying the database based on the one or more processed tokens.

26. The tangible computer-readable medium of claim 25, wherein the step of processing further comprises processing the one or more inputted natural language descriptions to generate the one or more processed tokens by splitting the one or more inputted natural language descriptions at one or more space characters in the one or more inputted natural language descriptions.

27. The tangible computer-readable medium of claim 25, wherein the step of processing further comprises processing the one or more inputted natural language descriptions to generate the one or more processed tokens by:
splitting the one or more inputted natural language descriptions at one or more space characters in the one or more inputted natural language descriptions to generate one or more pre-processed tokens; and
removing stop words from the one or more pre-processed tokens to generate the one or more processed tokens.

28. The tangible computer-readable medium of claim 25, wherein the step of processing further comprises processing the one or more inputted natural language descriptions to generate the one or more processed tokens by:
splitting the one or more inputted natural language descriptions at one or more space characters in the one or more inputted natural language descriptions to generate one or more pre-processed tokens;
removing stop words from the one or more pre-processed tokens to generate one or more intermediate tokens; and
reducing the one or more intermediate tokens to their stems to generate the one or more processed tokens.

29. The tangible computer-readable medium of claim 21,
wherein the software instructions stored on the tangible computer-readable medium, when executed by the computer system, further cause the computer system to carry out a step of processing the results set to generate one or more processed results, and
wherein the step of calculating comprises calculating the health-related rating for the requested food item based on the one or more processed results.
